(19) United States
(12) Patent Application Publication
(10) Pub. No.: US 2012/0019130 A1
(43) Pub. Date: Jan. 26, 2012

(54) IMAGE DISPLAY APPARATUS

(75) Inventors: Yuichiro Miyauchi, Odawara-shi (JP); Taro Hiroike, Yamato-shi (JP); Kazushi Nomura, Sagamihara-shi (JP)

(73) Assignee: CANON KABUSHIKI KAISHA, Tokyo (JP)

(21) Appl. No.: 13/172,232

(22) Filed: Jun. 29, 2011

(30) Foreign Application Priority Data
Jul. 26, 2010 (JP) 2010-167063

(51) Int. Cl. H01J 63/06

(52) U.S. Cl. 313/505

(57) ABSTRACT

The present invention provides an image display apparatus which reduces electrical discharges produced by electron-emitting devices and prevents image degradation during discharge. The image display apparatus includes a rear plate equipped with information wirings, scan wirings, an insulating layer and electron-emitting devices; and a face plate placed opposite to the rear plate and equipped with an anode and light emitting members, wherein the electron-emitting devices are placed between first and second scan wirings adjacent to each other, and are electrically connected to the first scan wiring, the second scan wiring is electrically connected to a discharge induction electrode via a contact hole which penetrates the insulating layer, one end of the discharge induction electrode is covered with the insulating layer, and the other end extends out from the insulating layer in a direction toward the electron-emitting devices.

### BACKGROUND OF THE INVENTION

1. Field of the Invention

The present invention relates to a flat-panel image display apparatus using electron-emitting devices.

2. Description of the Related Art

Conventionally known flat-panel image display apparatus using electron-emitting devices include an image display apparatus which includes an electron source substrate (rear plate) and a counter substrate (face plate) placed opposite to each other, where a large number of electron-emitting devices are formed on the electron source substrate and an anode and light emitting members are mounted on the counter substrate. In the image display apparatus, electrons are emitted from the electron-emitting devices when a voltage is applied between cathode electrodes and gate electrodes of the electron-emitting devices. The emitted electrons are directed at the light emitting members to emit light. In so doing, to cause high-intensity light emission, it is desirable to increase a difference between an anode potential and a cathode-gate electrode potential. However, increasing the potential difference produces a high electric field between the anode and the electron-emitting devices, making electrical discharges liable to occur between the anode and the electron-emitting devices. Such electrical discharges can cause excessive current to flow through the electron-emitting devices, thereby causing electron emission characteristics to vary from one electron-emitting device to another.

Japanese Patent Application Laid-Open No. 2006-209990 discloses a technique for preventing damage to electron-emitting devices adjacent to a discharging electron-emitting device by blocking and absorbing a secondary discharge (arc discharge) using an additional electrode when the secondary discharge occurs connecting an electron emission unit of the discharging electron-emitting device with electron emission units of the adjacent devices.

With the technique disclosed in Japanese Patent Application Laid-Open No. 2006-209990, although discharge current produced by the discharge is absorbed by the additional electrode, the discharge current also flows from the additional electrode to scan wirings connected with the electron-emitting devices because the additional electrode is connected to the scan wirings connected with the electron-emitting devices. This reduces drive voltage of the electron-emitting devices, resulting in image degradation during discharge.

Also, with the technique disclosed in Japanese Patent Application Laid-Open No. 2006-209990, the additional electrode, which is placed on an insulating layer, is allowed to have a smaller area than the insulating layer, and thus cannot be brought close to the electron-emitting devices. This makes it difficult for the additional electrode to serve as a lightning conductor, which in turn makes it impossible to reduce the electrical discharges produced by the electron-emitting devices.

### SUMMARY OF THE INVENTION

Thus, an object of the present invention is to provide an image display apparatus which reduces electrical discharges produced by electron-emitting devices and prevents image degradation during discharge.

In order to achieve the object, according to a one aspect of the present invention, an image display apparatus comprises: a rear plate provided with a plurality of information wirings, a plurality of scan wirings arranged over the information wirings in a direction of crossing the information wirings, an insulating layer arranged between the information wirings and the scan wirings along the scan wirings, and a plurality of electron-emitting devices each electrically connected to each of the information wirings and to each of the scan wirings; and a face plate provided with an anode electrode and a light-emitting member irradiated with an electron emitted from the electron-emitting device, and arranged in opposition to the rear plate, wherein the electron-emitting device is arranged between the scan wirings adjacent to each other and is electrically connected to one of the adjacent scan wirings, the other of the adjacent scan wirings is electrically connected to a discharge induction electrode through a contact hole penetrating the insulating layer, and wherein one end portion of the discharge induction electrode is covered with the insulating layer, the other end portion of the discharge induction electrode is extended from the insulating layer toward the electron-emitting device.

Thereby, the image display apparatus which reduces electrical discharges produced by electron-emitting devices and prevents image degradation during discharge can be provided advantageously.

Further features of the present invention will become apparent from the following description of exemplary embodiments with reference to the attached drawings.

### BRIEF DESCRIPTION OF THE DRAWINGS

FIG. 1A is a diagram illustrating an example of a rear plate suitably used in the present invention.

FIG. 1B is a diagram illustrating an example of a rear plate suitably used in the present invention.

FIG. 1C is a diagram illustrating an example of a rear plate suitably used in the present invention.

FIG. 2 is a diagram illustrating an image display apparatus according to the present invention.

FIG. 3 is a diagram illustrating potentials of electrodes in the image display apparatus according to the present invention.

FIG. 4A-1 is a diagram illustrating production steps of the rear plate illustrated in FIGS. 1A, 1B and 1C.

FIG. 4A-2 is a diagram illustrating production steps of the rear plate illustrated in FIGS. 1A, 1B and 1C.

FIG. 4B-1 is a diagram illustrating production steps of the rear plate illustrated in FIGS. 1A, 1B and 1C.

FIG. 4B-2 is a diagram illustrating production steps of the rear plate illustrated in FIGS. 1A, 1B and 1C.

FIG. 4C-1 is a diagram illustrating production steps of the rear plate illustrated in FIGS. 1A, 1B and 1C.

FIG. 4C-2 is a diagram illustrating production steps of the rear plate illustrated in FIGS. 1A, 1B and 1C.

FIG. 4D-1 is a diagram illustrating production steps of the rear plate illustrated in FIGS. 1A, 1B and 1C.

FIG. 4D-2 is a diagram illustrating production steps of the rear plate illustrated in FIGS. 1A, 1B and 1C.

FIG. 4E-1 is a diagram illustrating the production steps of the rear plate illustrated in FIGS. 1A, 1B and 1C.

FIG. 4E-2 is a diagram illustrating the production steps of the rear plate illustrated in FIGS. 1A, 1B and 1C.

FIG. 4F-1 is a diagram illustrating the production steps of the rear plate illustrated in FIGS. 1A, 1B and 1C.

FIG. 4F-2 is a diagram illustrating the production steps of the rear plate illustrated in FIGS. 1A, 1B and 1C.

FIG. 4G-1 is a diagram illustrating the production steps of the rear plate illustrated in FIGS. 1A, 1B and 1C.

FIG. 4G-2 is a diagram illustrating the production steps of the rear plate illustrated in FIGS. 1A, 1B and 1C.

FIG. 4H-1 is a diagram illustrating the production steps of the rear plate illustrated in FIGS. 1A, 1B and 1C.

FIG. 4H-2 is a diagram illustrating the production steps of the rear plate illustrated in FIGS. 1A, 1B and 1C.

FIG. 4I-1 is a diagram illustrating the production steps of the rear plate illustrated in FIGS. 1A, 1B and 1C.

FIG. 4I-2 is a diagram illustrating the production steps of the rear plate illustrated in FIGS. 1A, 1B and 1C.

FIG. 5 is a diagram illustrating a rear plate according to example 2.

FIG. 6 is a diagram illustrating a rear plate according to example 3.

### DESCRIPTION OF THE EMBODIMENTS

Preferred embodiments of the present invention will now be described in detail in accordance with the accompanying drawings.

Electron-emitting devices available for use in the present invention include field emission devices, MIM devices and surface conduction electron-emitting devices, among which the surface conduction electron-emitting devices which allow voltages of a few kV or above to be applied are suitably used, especially from the perspective of ease of discharging.

(Configuration of Rear Plate)

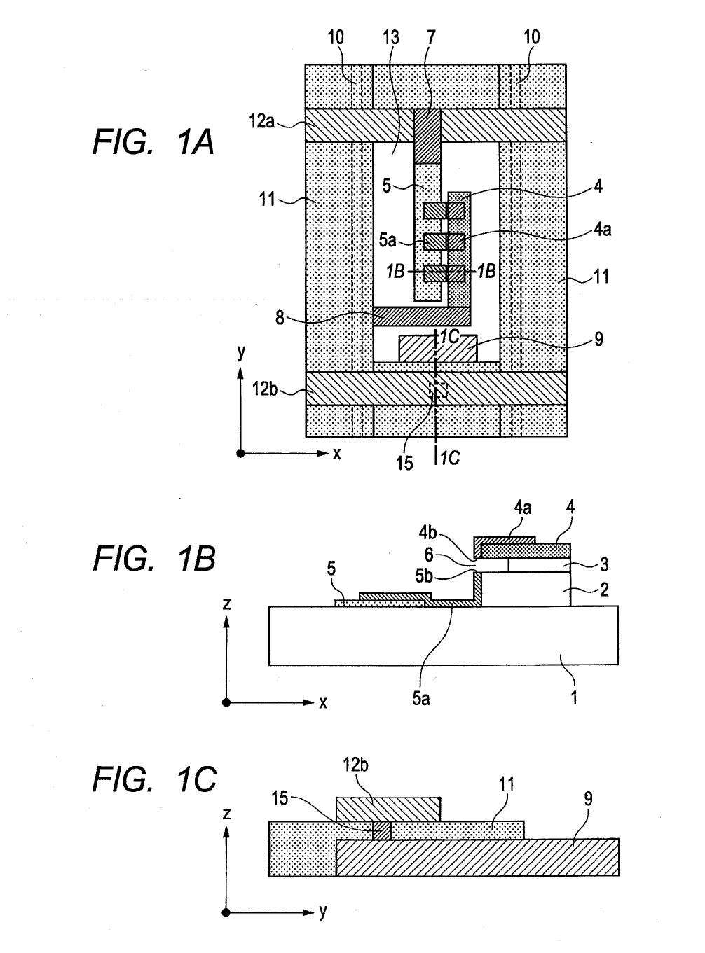

FIGS. 1A to 1C are schematic diagrams illustrating an embodiment of a rear plate equipped with the electron-emitting device according to the present invention, where FIG. 1A is a plan view, FIG. 1B is a sectional view taken along line 1B-1B in FIG. 1A, and FIG. 1C is a sectional view taken along line 1C-1C in FIG. 1A.

The electron-emitting device 13 according to the present invention is basically configured by forming a cathode electrode 5 and gate electrode 4 on an insulating substrate 1. The cathode electrodes 5 and gate electrodes 4 are arranged alternately in parallel to each other with mutually adjacent cathode electrodes 5 and gate electrodes 4 being paired with each other (FIG. 1A). Hereinafter, the direction from the cathode electrode 5 to the pairing gate electrode 4 will be referred to as an x direction. Also, the direction orthogonal to the x direction and parallel to a surface of the insulating substrate 1 will be referred to as a y direction. Furthermore, the direction orthogonal to both the x direction and y direction will be referred to as a z direction.

The electron-emitting device according to the present invention emits electrons when a voltage at or above a threshold voltage is applied between the cathode electrode 5 and gate electrode 4. Quantities of electrons emitted are controlled by a crest value and pulse width of the pulsed voltage applied between the electrodes. On the other hand, since electrons are rarely emitted at or below the threshold voltage, amounts of electron emission can be controlled if necessary electron-emitting devices are selected by the application of pulsed voltages to x-direction wirings and y-direction wirings.

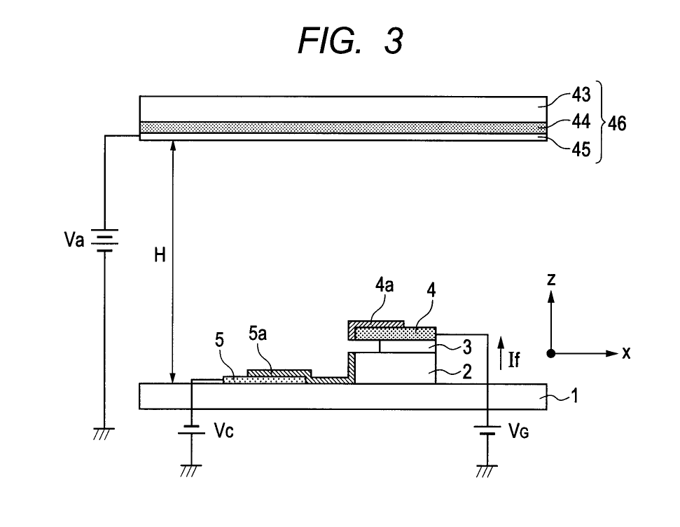

The gate electrode 4 is formed on a first insulating layer 2 and second insulating layer 3 stacked on the insulating substrate 1 and has a protruding portion 4a on part of its y-direction side closer to the pairing cathode electrode 5 (FIG. 1B). Furthermore, the protruding portion 4a of the gate electrode 4 falls along the gate electrode 4 from the side closer to the pairing cathode electrode 5 and reaches an end point 4b. The gate electrode 4 and the protruding portion 4a thereof may be formed either integrally as a single member or separately as separate members. Also, the gate electrode 4 is electrically connected with an information wiring 10 via a gate connection electrode 8 (FIG. 1A), and a gate potential V_{G} is applied through the information wiring 10 as shown in FIG. 3 when the electron-emitting device 13 is driven.

The cathode electrode 5 is formed on the insulating substrate 1 and has a protruding portion 5a on part of its y-direction side closer to the pairing gate electrode 4 (FIG. 1B). Furthermore, the protruding portion 5a of the cathode electrode 5 protrudes from the side closer to the pairing gate electrode 4, rises midway along the first insulating layer 2, and reaches an end point 5b. The end point 5b of the protruding portion of the cathode electrode is placed so as to face the end point 4b of the protruding portion of the pairing gate electrode across a minute gap 6. The cathode electrode 5 and the protruding portion 5a thereof may be formed either integrally as a single member or separately as separate members. Also, the cathode electrode 5 is electrically connected with a scan wiring 12a via a cathode connection electrode 7 (FIG. 1A), and a cathode potential V_{C} is applied through the scan wiring 12a as shown in FIG. 3 when the electron-emitting device 13 is driven. The cathode potential V_{C} is lower than the gate potential V_{G}.

Thus, when the electron-emitting device 13 is driven, a difference potential between the gate potential V_{G} and cathode potential V_{C} is applied to the gap 6 formed between the end point 5b of the protruding portion of the cathode electrode and the end point 4b of the protruding portion of the pairing gate electrode. Consequently, an electric field is produced in the gap 6, generating electrons at the end point 5b of the protruding portion of the cathode electrode. That is, the gap 6 functions as an electron emission unit. Incidentally, multiple protruding portions 5a of the cathode electrode and multiple protruding portions 4a of the gate electrode may be formed in each pair of the cathode electrode 5 and gate electrode 4, for example, as shown in FIG. 1A.

The information wirings 10 are arranged along the y direction, the scan wirings 12 are installed above the information wirings 10 in a direction intersecting the information wirings 10, and an insulating layer 11 is provided along the scan wirings 12 by passing between the information wirings 10 and scan wirings 12 (FIG. 1A). Alternatively, the information wirings 10 may be arranged along the x direction and the scan wirings 12 may be arranged along the y direction.

A plurality of the electron-emitting devices 13 are provided, being electrically connected with the information wirings 10 and scan wirings 12. Each electron-emitting device 13 is placed between a first scan wiring 12a and second scan wiring 12b adjacent to each other (FIG. 1A).

A discharge induction electrode 9 is made of a conductive material and is covered at one end with the insulating layer 11. That end of the discharge induction electrode 9 which is covered with the insulating layer 11 is electrically connected with the second scan wiring 12b through a contact hole provided in the insulating layer 11 (FIG. 1C). This is intended to dissipate a discharge current produced by electrical discharges to the scan wiring 12b through the discharge induction electrode 9. From among the electron-emitting devices placed between the first and second scan wirings 12a and 12b, the other end of the discharge induction electrode 9 is exposed and extended out to a location closer to a first electron-emitting device 13 which is driven when the first scan wiring 12a is selected and the second scan wiring 12b is non-selected than to the insulating layer 11. This is intended to guide electrical discharges produced between the anode and electron-emitting device to the discharge induction electrode 9 and thereby cause the exposed portion of the discharge induction electrode 9 to discharge. Consequently, the present invention can reduce the electrical discharges produced by the electron-emitting device. Incidentally, the larger the exposed portion of the discharge induction electrode 9, the larger the rate at which electrical discharges are produced by the exposed portion of the discharge induction electrode 9, and consequently, the higher the effect of reducing the electrical discharges produced by the electron-emitting device.

When an electrical discharge occurs, a cathode spot appears as the discharging progresses. The cathode spot is an electron emission point which appears during discharge and is an injection point of the discharge current from the anode (see J. Appl. Phys., vol. 51, No. 3, 1414 (1980)). The cathode spot moves to the side of lower potential. Therefore, if an electrical discharge occurs on the exposed portion of the discharge induction electrode 9, the cathode spot moves from the exposed portion of the discharge induction electrode 9 to the scan wiring 12b. The cathode spot reaches an end of the insulating layer 11 on the way to the scan wiring 12b, but is kept by the insulating layer 11 from going beyond the end of the insulating layer 11. Consequently, the cathode spot stays at the end. As the cathode spot stays at the end, the discharge induction electrode 9 melts by being heated, and may get broken. Thus, to prevent the discharge induction electrode 9 from being melted and broken, desirably the discharge induction electrode 9 is configured to satisfy expressions (a) to (c) below.

Ee=P×Cp×ρ×Tm (a)

Ea=R×I²×t₁ (b)

Ee>Ea (c)

where P is the volume [m³] of the discharge induction electrode in a range from a site of connection with the wiring to the end facing the connection site, Cp is the specific heat at constant pressure [J/kgK] of the discharge induction electrode, ρ is the density [kg/m³] of the discharge induction electrode, Tm is the melting point [K] of the discharge induction electrode, R is the resistance [Ω] of the discharge induction electrode in the range from the site of connection with the wiring to the end facing the connection site, I is an allowable current value [A] of the discharge induction electrode, and t₁ is the duration [sec] of a discharge induction current flowing through the discharge induction electrode. Expressions (a) to (c) above mean that energy Ee dissipated when the discharge induction electrode 9 is melted is larger than energy Ea of the discharge current flowing through the discharge induction electrode 9.

In an image display apparatus using the electron-emitting devices 13 according to the present invention, the electron-emitting devices can be arranged in a matrix. Regarding a method for driving the electron-emitting devices 13 arranged in a matrix, desirably the electron-emitting devices 13 are matrix-driven by a plurality of information wirings and a plurality of scan wirings. The matrix-driving involves applying voltages to one or more scan wirings 12 selected in sequence out of scan wirings 12 arranged in lines along the x direction or y direction, causing the electron-emitting devices 13 to emit electrons in sequence as the scan wirings 12 are selected.

Suppose an image display apparatus in which the discharge induction electrode 9 is electrically connected with the scan wiring 12b as shown in FIGS. 1A to 1C and the electron-emitting devices 13 are arranged in a matrix is matrix-driven by selecting the scan wirings in sequence so that selected and non-selected scan wirings will alternate with each other. When the scan wiring 12a is selected, driving the appropriate electron-emitting device, and thereby generating an electrical discharge on the exposed portion of the discharge induction electrode 9, the discharge current is guided to the non-selected scan wiring 12b. At this point, an unillustrated electron-emitting device placed between the scan wiring 12b and an adjacent scan wiring (not shown) located on the opposite side of the scan wiring 12b from the scan wiring 12a is not driven. Consequently even if the potential is raised by the discharge current, the unillustrated electron-emitting device does not emit electrons.

Next, suppose an image display apparatus in which the discharge induction electrode 9 is electrically connected with the scan wiring 12a and the electron-emitting devices 13 are arranged in a matrix is matrix-driven. When a scan wiring 12a is selected, driving the appropriate electron-emitting device, and thereby generating an electrical discharge on the exposed portion of the discharge induction electrode 9, the discharge current flows through the selected scan wiring 12a. In this case, the drive voltage decreases, resulting in low luminance. For example, when the discharge current flows through the selected scan wiring 12a, decreasing the drive voltage of the electron-emitting device 13 by 1 V and approximately halving the luminance on a display surface, luminance degradation can be recognized visually.

Thus, according to the present invention, each electron-emitting device 13 is installed between two adjacent scan wirings 12a and 12b as shown in FIG. 1A. Also, that end of the discharge induction electrode 9 which is covered with the insulating layer 11 is electrically connected with the second scan wiring 12b through the contact hole provided in the insulating layer 11. From among the electron-emitting devices placed between the first and second scan wirings 12a and 12b, the other end of the discharge induction electrode 9 is exposed from the insulating layer 11 and extended out to a location closer to that electron-emitting device 13 which is driven when the first scan wiring 12a is selected and the second scan wiring 12b is non-selected than to the insulating layer 11.

In this way, being configured as illustrated in FIGS. 1A to 1C, the image display apparatus according to the present invention can prevent luminance degradation during discharge because the discharge current does not flow through the selected scan wirings if the discharge induction electrodes discharge when the electron-emitting devices are being driven. Also, the discharge current flowing through the information wirings can be reduced if the resistance of the scan wirings is set lower than the resistance of the information wirings. This is more desirable because of the effectiveness in preventing a situation in which the potential of the information wirings is raised, causing excessive current to flow through the remaining undriven electron-emitting devices and thereby causing electron emission characteristics to vary from one electron-emitting device to another.

Suppose an electron-emitting device 13 discharges in the image display apparatus according to the present invention configured as illustrated in FIGS. 1A to 1C. When the electron-emitting device 13 discharges, a cathode spot appears, and material of the electron emission unit as well as gases contained in the material evaporate and ionize, generating an ark. The arc spread at a constant acceleration due to ambipolar diffusion. However, with the configuration in FIGS. 1A to 1C, the arc spreading due to ambipolar diffusion is guided to, and absorbed by, the discharge induction electrode 9. The arc absorbed by the discharge induction electrode 9 extinguishes itself subsequently. This enables extinguishing the cathode spot initiated in the electron-emitting device 13. Desirably, distance between the gap 6 and discharge induction electrode 9 is not larger than 200 μm.

(Fabrication Method of Rear Plate)

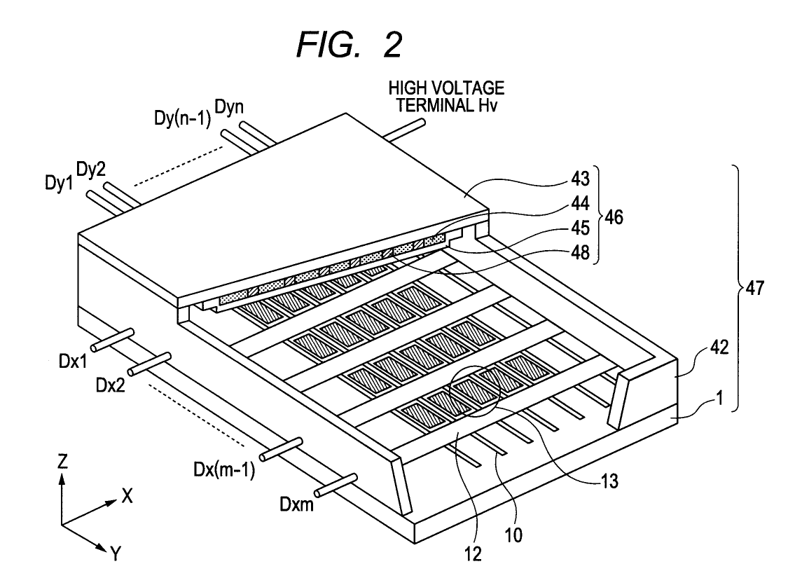

Next a fabrication method of the rear plate equipped with the electron-emitting devices according to the present invention will be described by citing the configuration in FIGS. 1A to 1C as an example and referring to FIGS. 4A-1 to 4I-1. FIGS. 4A-1 to 4I-1 are plan views and FIGS. 4A-2 to 4I-2 are sectional views taken along A-A and B-B in FIGS. 4A-1 to 4I-1.

First, as shown in FIGS. 4A-1 and 4A-2, insulating layers 21 and 22 and a conductive layer 23 are stacked in sequence on the substrate 1.

The substrate 1 is an insulating substrate which has sufficient strength to mechanically support electron-emitting devices 13, information wirings 10 and scan wirings 12 and is made of a material selected appropriately from insulating materials such as glass, soda lime glass, alumina and ceramics with reduced contents of impurities such as quartz glass and Na. Features required of the substrate 1 include resistance to alkalis and acids of dry etching, wet etching and developing solutions as well as mechanical strength.

The insulating layers 21 and 22 are insulating films made of a material, such as SiN(SiₓN_{y}) or SiO₂, with excellent workability and are formed by a typical vapor film forming technique such as a sputtering process, CVD process or vapor deposition process. The insulating layers 21 and 22 are 5 nm to 50 μm thick, and desirably 10 nm to 1 μm thick. The insulating layers 21 and 22 may be equal in thickness. Also, the insulating layers 21 and 22 are desirably made of materials which differ in etching speed. Desirably, etching selectivity between the insulating layers 21 and 22 is 10 or above, and more desirably 50 or above. Specifically, for example, SiₓN_{y} can be used for the insulating layer 21 while insulating material such as SiO₂, PSG with a high phosphorus concentration, or BSG film with a high boron concentration can be used for the insulating layer 22.

The conductive layer 23 is used as the gate electrode 4 and gate connection electrode 8 shown in FIG. 1A and is formed by a typical vapor film forming technique such as a sputtering process, CVD process or vapor deposition process. A material which has a high thermal conductivity and a high melting point in addition to electrical conductivity is suitable for the conductive layer 23. Examples of such materials include metals such as Be, Mg, Ti, Zr, Hf, V, Nb, Ta, Mo, W, Al, Cu, Ni, Cr, Au, Pt and Pd and alloys thereof; carbides such as TiC, ZrC, HfC, TaC, SiC and WC; borides such as HfB₂, ZrB₂, CeB₆, YB₄ and GdB₄; nitrides such as TiN, ZrN, HfN and TaN; semiconductors such as Si and Ge; organic polymeric materials; amorphous carbon; graphite; diamond-like carbon; and diamond-dispersed carbon and carbon compounds, from which an appropriate material can be selected. The conductive layer 23 is 5 nm to 500 nm thick, and desirably 20 nm to 500 nm thick.

Next, as shown in FIGS. 4B-1 and 4B-2, the discharge induction electrodes 9 and information wirings 10 are formed on the conductive layer 23. The discharge induction electrodes 9 and information wirings 10 may be formed in the same step. Available formation methods include typical vapor film forming techniques such as a sputtering process, CVD process and vapor deposition process; typical printing techniques such as a photo-pasting process; a plating process; and a photolithographic process.

A material which has a high thermal conductivity and a high melting point in addition to electrical conductivity is suitable for the discharge induction electrode 9. Examples of such materials include metals such as Be, Mg, Ti, Zr, Hf, V, Nb, Ta, Mo, W, Al, Cu, Ni, Cr, Au, Pt and Pd and alloys thereof; carbides such as TiC, ZrC, HfC, TaC, SiC and WC; borides such as HfB₂, ZrB₂, CeB₆, YB₄ and GdB₄; nitrides such as TiN, ZrN, HfN and TaN; semiconductors such as Si and Ge; organic polymeric materials; graphite; and carbon compounds such as carbon nanotubes, from which an appropriate material can be selected. For example, when the discharge current is about 1 A and Cu is used as the material for the discharge induction electrode 9, the discharge induction electrode 9 is 10 nm to a few tens of mm thick, and desirably 100 nm to 100 μm thick. More desirably the discharge induction electrode 9 is configured to satisfy expressions (a) to (c) above in order to prevent the discharge induction electrode 9 from being melted and broken.

A material which has a high thermal conductivity and a high melting point in addition to electrical conductivity is suitable for the information wiring 10. Examples of such materials include metals such as Be, Mg, Ti, Zr, Hf, V, Nb, Ta, Mo, W, Al, Cu, Ni, Cr, Au, Pt and Pd and alloys thereof; carbides such as TiC, ZrC, HfC, TaC, SiC and WC; borides such as HfB₂, ZrB₂, CeB₆, YB₄ and GdB₄; nitrides such as TiN, ZrN, HfN and TaN; semiconductors such as Si and Ge; organic polymeric materials; graphite; and carbon compounds such as carbon nanotubes, from which an appropriate material can be selected. The information wiring 10 is 10 nm to a few tens of mm thick, and desirably 100 nm to 100 μm thick.

Next, as shown in FIGS. 4C-1 and 4C-2, a resist pattern is formed on the conductive layer 23 by a photolithographic technique, and then the conductive layer 23, insulating layer 22 and insulating layer 21 are processed in sequence using an etching method. This produces the gate electrodes 4, gate connection electrodes 8, second insulating layer 3 and first insulating layer 2. Such an etching process generally uses RIE (Reactive Ion Etching) capable of performing precision etching by directing etching gas turned into plasma at the material. As a process gas for that, fluorine-based gas such as CF₄, CHF₃ or SF₆ is used when a material which forms a fluoride is processed, and chlorine-based gas such as Cl₂ or BCl₃ is used when a material such as Si or Al which forms a chloride is processed. Also, to maintain the etching selectivity relative to the resist, ensure smoothness of etched surfaces, or increase etching speed, hydrogen, oxygen, argon and/or other gases are added as required. The etching process may be stopped before etching a top surface of the substrate 1, after etching part of the substrate 1, or after etching halfway through the insulating layer 21. If the etching process is stopped after etching halfway through the insulating layer 21, the remaining part of the insulating layer 21 and the substrate 1 can be taken together as the substrate 1. Also, the length of the gate electrode 4 in the x direction and spacing between adjacent gate electrodes may be changed as required according to the size of the electron-emitting device or size of an image forming apparatus to which the electron-emitting device is applied.

Next, as shown in FIGS. 4D-1 and 4D-2, the insulating layer 11 is formed by a typical vapor film forming technique such as a sputtering process, CVD process or vapor deposition process. It is important to form the insulating layer 11 so as to cover part or all of the information wiring 10 which is lower-layer wiring. The insulating layer 11 is necessary especially at intersections between the information wirings 10 and scan wirings 12 to provide electrical insulation between the two types of wiring. Any material with good insulation properties or high resistance may be used for the insulating layer 11, and SiN(SiₓN_{y}), SiO₂ and the like can be used suitably. The insulating layer 11 is 5 nm to 50 μm thick, and desirably 10 nm to 1 μm thick.

Next, as shown in FIGS. 4E-1 and 4E-2, a resist pattern is formed on the insulating layer 11 by a photolithographic technique, and then the contact holes 15 used to electrically interconnect the scan wirings 12 and discharge induction electrodes 9 are formed using an etching method.

Next, as shown in FIGS. 4F-1 and 4F-2, scan wirings 12 are formed on part of the insulating layer 11 to bury the contact holes 15. Available formation methods include typical vapor film forming techniques such as a sputtering process, CVD process and vapor deposition process; typical printing techniques such as a photo-pasting process; a plating process; and a photolithographic process. A material which has a high thermal conductivity and a high melting point in addition to electrical conductivity is suitable for the scan wiring 12. Examples of such materials include metals such as Be, Mg, Ti, Zr, Hf, V, Nb, Ta, Mo, W, Al, Cu, Ni, Cr, Au, Pt and Pd and alloys thereof; carbides such as TiC, ZrC, HfC, TaC, SiC and WC; borides such as HfB₂, ZrB₂, CeB₆, YB₄ and GdB₄; nitrides such as TiN, ZrN, HfN and TaN; semiconductors such as Si and Ge; organic polymeric materials; graphite; and carbon compounds such as carbon nanotubes, from which an appropriate material can be selected. The scan wiring 12 is 10 nm to a few tens of mm thick, and desirably 100 nm to 100 μm thick.

Next, as shown in FIGS. 4G-1 and 4G-2, a recess 14 is formed in one side face of a laminate made up of the first insulating layer 2, second insulating layer 3 and gate electrodes 4 by partially removing a side face of only the second insulating layer 3 using an etching method. Also, the insulating layer 11 is partially removed using an etching method to form the exposed portions of the discharge induction electrodes 9. The etching method can use a mixed solution of ammonium fluoride and hydrofluoric acid, popularly known as buffered hydrofluoric acid (BHF), if, for example, the second insulating layer 3 and insulating layer 11 are made of SiO₂. A heat phosphate-based etching solution can be used if the second insulating layer 3 and insulating layer 11 are made of SiₓN_{y}. The larger the depth of the recess 14, i.e., the distance between the side face of the second insulating layer 3 and side face of the first insulating layer 2 in the recess, the higher the effect of reducing leakage current during driving, and thus the better it is. However, if the recess 14 is too deep, the gate electrode 4 may get deformed or collapse, and thus the depth is set appropriately taking this point into consideration. Desirably the depth of the recess 14 is generally about 30 nm to 200 nm. Although in FIGS. 4A-1 to 4I-2, the first insulating layer 2 and second insulating layer 3 are shown as being stacked, the electron-emitting device according to the present invention is not limited to this. The recess 14 may be formed by removing part of one insulating layer. Alternatively, both the first insulating layer 2 and second insulating layer 3 may have a multilayer structure.

Next, as shown in FIGS. 4H-1 and 4H-2, the cathode electrode 5 and cathode connection electrode 7 are formed. A material which has a high thermal conductivity and a high melting point in addition to electrical conductivity is suitable for the cathode electrode 5. Examples of such materials include metals such as Be, Mg, Ti, Zr, Hf, V, Nb, Ta, Mo, W, Al, Cu, Ni, Cr, Au, Pt and Pd and alloys thereof; carbides such as TiC, ZrC, HfC, TaC, SiC and WC; borides such as HfB₂, ZrB₂, CeB₆, YB₄ and GdB₄; nitrides such as TiN, ZrN, HfN and TaN; semiconductors such as Si and Ge; organic polymeric materials; amorphous carbon; graphite; diamond-like carbon; and diamond-dispersed carbon and carbon compounds, from which an appropriate material can be selected. The cathode electrode 5 is 5 nm to 500 nm thick, and desirably 20 nm to 500 nm thick. The length of the cathode electrode 5 in the x direction may be changed as required.

Next, as shown in FIGS. 4I-1 and 4I-2, the protruding portions 5a of the cathode electrodes and protruding portions 4a of the gate electrodes are formed. The protruding portions 5a of the cathode electrodes and protruding portions 4a of the gate electrodes may be formed using a photolithographic technique after a thin conductive film is formed by a typical vapor film forming technique such as a sputtering process, CVD process or vapor deposition process. Thanks to the presence of the recesses 14, the minute gaps 6 are formed automatically between the end points of the protruding portions 5a of the cathode electrodes and protruding portions 4a of the gate electrodes. Any material which has electrical conductivity and allows field emission may be used as a conductive material, but generally it is desirable that the material has a high melting point of 2000° C. or above and a work function of 5 eV or below and does not allow easy formation of a chemical reaction layer of an oxide or the like or allows easy removal of chemical reaction layers. Examples of such materials include metals such as Hf, V, Nb, Ta, Mo, W, Au, Pt and Pd and alloys thereof; carbides such as TiC, ZrC, HfC, TaC, SiC and WC; borides such as HfB₂, ZrB₂, CeB₆, YB₄ and GdB₄; nitrides such as TiN, ZrN, HfN and TaN; amorphous carbon; graphite; diamond-like carbon; and diamond-dispersed carbon and carbon compounds. Available deposition methods for conductive materials include typical vapor film forming techniques such as a sputtering process, CVD process and vapor deposition process, and EB vapor deposition is used suitably.

(Configuration of Image Display Apparatus)

Next, an image display apparatus equipped with the rear plate according to the present invention will be described.

Generally, an image display apparatus has a plurality of electron-emitting devices arranged in a matrix in the x direction and y direction. The cathode electrodes or gate electrodes of a plurality of electron-emitting devices placed in the same row are electrically connected to a common wiring in the x direction while the cathode electrodes or gate electrodes of a plurality of electron-emitting devices placed in the same column are electrically connected to a common wiring in the y direction. An image display apparatus which uses, as an electron source, the electron-emitting devices arranged in this way in a so-called simple matrix will be described with reference to FIG. 2.

FIG. 2 is a perspective view illustrating an embodiment of the image display apparatus according to the present invention, partially cut away to show internal structure. The substrate 1 is a rear plate on whose surface m x-direction wirings 12 (scan wirings) and n y-direction wirings 10 (information wirings) are installed, where both m and n are positive integers. The insulating layer 11 is installed between the m scan wirings 12 and n information wirings 10, electrically insulating the scan wirings and information wirings. Each row of electron-emitting devices 13 is installed between first and second scan wirings 12 adjacent to each other and a total of m×n electron-emitting devices 13 are arranged in a simple matrix. That end of the discharge induction electrode 9 which is covered with the insulating layer 11 is electrically connected with the second scan wiring through the contact hole provided in the insulating layer 11. From among the electron-emitting devices placed between the two adjacent scan wirings 12, the other end of the discharge induction electrode 9 is exposed from the insulating layer 11 and extended out to a location closer to that electron-emitting device 13 which is driven when the first scan wiring is selected and the second scan wiring is non-selected than to the insulating layer 11. The m scan wirings 12 are connected to respective terminals Dx1, Dx2, . . . , Dxm and the n information wirings 10 are connected to respective terminals Dy1, Dy2, . . . , Dyn, and thereby the scan wirings and information wirings are connected to a drive circuit placed externally.

A face plate 46 has a glass substrate 43 and components formed inside the glass substrate 43. The components include light emitting members 44 such as phosphors which emit light when irradiated with electrons, a black matrix 48, and a metal back 45. The metal back 45 functions as an anode and is connected to a high-voltage terminal HV and supplied with a DC voltage Va of, for example, 10 kV. The light emitting members 44 are installed on the metal back 45 (i.e., the anode). The black matrix 48, which is also called a black member, has a matrix form corresponding to the m×n matrix arrangement of the electron-emitting devices. Each cell of the black matrix 48 defines outer edges of an opening in the corresponding light emitting member 44 irradiated with electrons from the corresponding electron-emitting device 13. The black matrix 48 prevents color mixing among the phosphors and absorbs external light, thereby improving image contrast.

In the image display apparatus according to the present embodiment, the substrate 1 (rear plate) with the electron-emitting devices installed thereon and the face plate 46 placed opposite the rear plate are connected to a support frame 42 via a sealing member such as flit glass, forming an envelope 47. The envelope 47 is sealed when fired at a temperature of 400° C. to 500° C. in the atmosphere or in nitrogen for 10 minutes or more. With the sealed envelope 47 evacuated and the voltage Va applied to the metal back 45, a scanning signal and modulation signal are applied to the scan wirings 12 and information wirings 10, respectively, thereby accelerating the electrons emitted from the electron-emitting devices, to irradiate the light emitting members 44 with the electrons and thereby realize image display. Also, a support piece (not shown) called a spacer can be installed, as required, between the face plate 46 and rear plate to provide sufficient strength against the atmospheric pressure.

The present invention will be described in detail below by citing concrete examples. However, it should be noted that the present invention it not limited to configurations and forms used in the examples described below.

### Example 1

### Production of Rear Plate

In the present example, the rear plate shown in FIGS. 1A to 1C was produced. Steps of the production will be described below. FIGS. 4A-1 to 4I-2 show the production steps of the rear plate used in the present example.

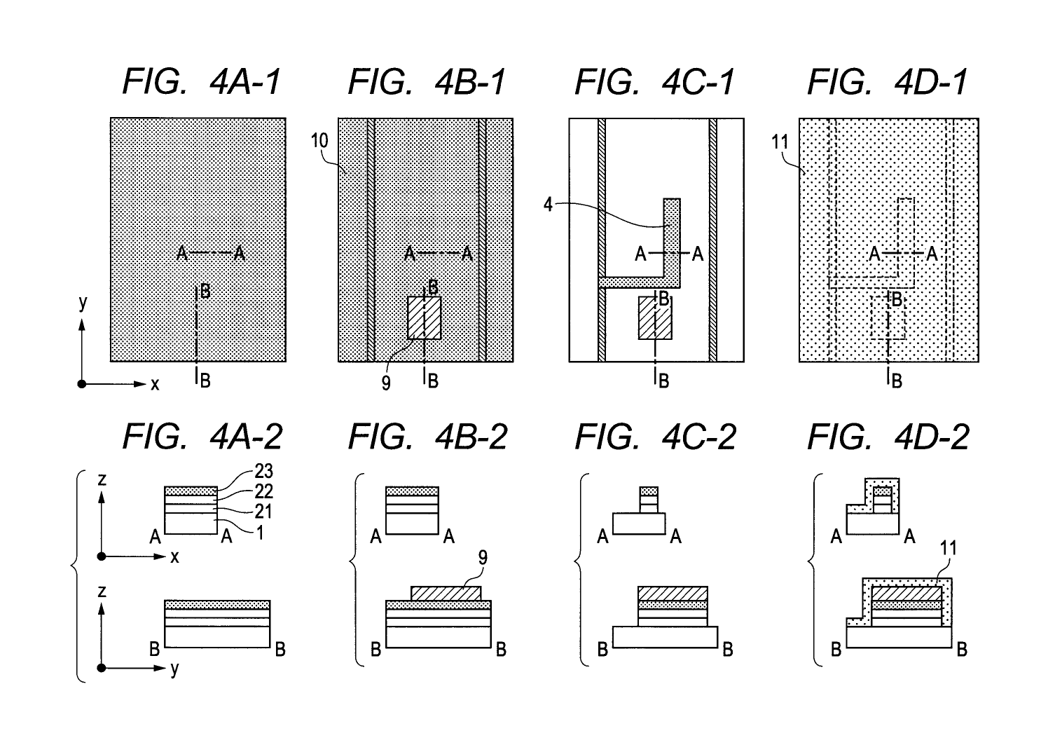

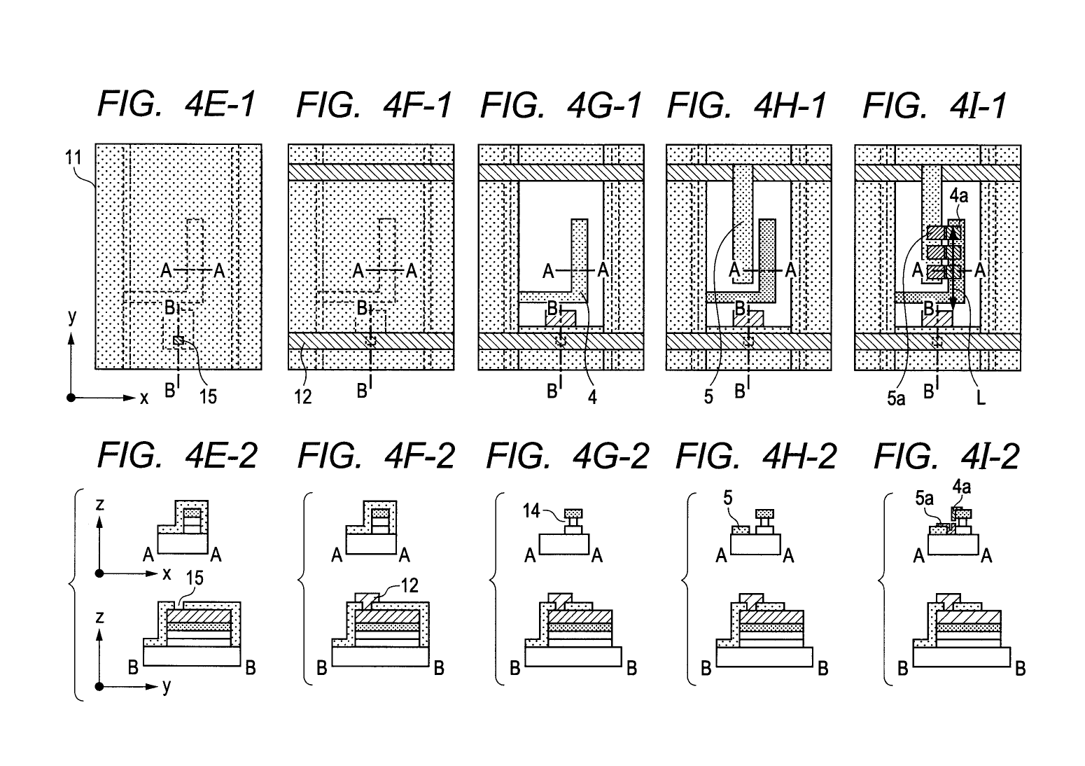

First, soda lime glass used as the substrate 1 was cleaned thoroughly. Then, on the substrate 1, a Si₃N₄ film 300 nm thick was deposited as the insulating layer 21, SiO₂ was deposited to a thickness of 20 nm as the insulating layer 22, and then TaN was deposited to a thickness of 30 nm as the conductive layer 23, all by sputtering (FIG. 4A-1).

Next, Cu was applied to a thickness of 5 μm by a plating process, and the discharge induction electrode 9 and information wirings 10 were formed by patterning in a photolithography step (FIG. 4B-1). The width of the discharge induction electrode 9 was 25 μm.

Next, a positive photoresist was spin coated, a photomask pattern was exposed and developed, and a resist pattern corresponding to a gate electrode and gate connection electrode was formed. The width of the gate electrode was 10 μm and length of the gate electrode was 100 μm. Subsequently, using the patterned photoresist as a mask, the conductive layer 23, insulating layer 22 and insulating layer 21 were dry etched using CF₄ gas. The dry etching was stopped on the substrate 1, forming a laminate made up of the first insulating layer 2, the second insulating layer 3, and the gate electrode 4 including the gate connection electrode 8 (FIG. 4C-1).

Next, a 5-μm-thick film of SiO₂ was formed as the insulating layer 11 by a CVD process (FIG. 4D-1).

Next, a positive photoresist was spin coated, a photomask pattern was exposed and developed, and a resist pattern was formed, excluding a location of the contact hole 15 for use to electrically interconnect the scan wirings 12 and the discharge induction electrode 9. Then, using buffered hydrofluoric acid (BHF) (LAL100 produced by Stella Chemifa Corporation) as an etching solution, the SiO₂ film was removed by a wet etching process to form the contact hole 15 (FIG. 4E-1).

Next, the scan wirings 12 were formed to a thickness of 5 μm by plating with Cu (FIG. 4F-1).

Next, a positive photoresist was spin coated, a photomask pattern was exposed and developed, and a resist pattern was formed, excluding a location of the electron source. Then, using buffered hydrofluoric acid (BHF) (LAL100 produced by Stella Chemifa Corporation) as an etching solution, the SiO₂ film was removed by a wet etching process from part of the region on the gate electrode 4 and the discharge induction electrode 9, thereby exposing part of a pattern for the laminate made up of the first insulating layer 2, second insulating layer 3 and gate electrode 4. At the same time, the recess 14 was formed by selectively etching the second insulating layer 3 (FIG. 4G-1). The y-direction length of the discharge induction electrode 9 was 60 μm from the scan wirings 12. Consequently, in expressions (a) to (c) above, Ee=2.8×10⁻⁵, Ea=8.1×10⁻⁵, and thus Ee>Ea was satisfied.

Next, Mo was deposited to a thickness of 50 nm by a sputtering process, and the cathode electrode 5 including the cathode connection electrode 7 was formed in the photolithography step (FIG. 4H-1).

Next, Mo was selectively deposited obliquely from above at an angle of 45° to a thickness of 10 nm by EB oblique-angle deposition. Subsequently, a resist pattern was formed in the photolithography step and Mo was dry etched using CF₄ gas, thereby forming a pattern for the protruding portions 5a of the cathode electrode and protruding portions 4a of the gate electrode. In so doing, the protruding portions 5a and 4a of the cathode electrode and gate electrode were formed by making sure that distance L from the protruding portions 5a and 4a nearest the side of the scan wirings 12a to the discharge induction electrode 9 would not exceed 150 μm (FIG. 4I-1).

(Production of Image Display Apparatus)

The electron-emitting devices produced by the above method were arranged in a 720×160 matrix to produce the image display apparatus shown in FIG. 2. Each row of electron-emitting devices 13 was installed between first and second scan wirings adjacent to each other. That end of the discharge induction electrode 9 which was covered with the insulating layer 11 was electrically connected with the second scan wiring through the contact hole provided in the insulating layer 11. From among the electron-emitting devices placed between the first and second scan wirings, the other end of the discharge induction electrode 9 was exposed from the insulating layer and was extended out to a location closer to that electron-emitting device 13 which was driven when the first scan wiring was selected and the second scan wiring was non-selected than to the insulating layer 11. The face plate 46 including the glass substrate 43 as well as the light emitting members 44, black matrix 48, and metal back 45 formed inside the glass substrate 43 was sealed via the support frame 42 in vacuum 2 mm above the substrate 1, forming the envelope 47. Two spacers (not shown) measuring 2 mm in thickness and 200 μm in width were placed between the substrate 1 and face plate 46 to provide a structure capable of withstanding the atmospheric pressure. Indium was used to join together the substrate 1, support frame 42 and face plate 46. Furthermore, an evaluation image display apparatus was produced using the same method.

Also, another image display apparatus without a discharge induction electrode 9 was produced for comparison. The comparison image display apparatus had the same configuration as the evaluation image display apparatus according to the present example except that the comparison image display apparatus did not have a discharge induction electrode 9 and the fabrication method of the comparison image display apparatus was the same as that of the evaluation image display apparatus according to the present example except that no discharge induction electrode 9 was installed during production of the rear plate, and thus description thereof will be omitted.

(Evaluation of Image Display Apparatus)

The evaluation image display apparatus and comparison image display apparatus thus produced were matrix-driven, and a discharge was induced, by application of an excessive voltage, in one electron-emitting device driven by a selected scan wiring. Values of current were measured on two scan wirings: the selected scan wiring driving the electron-emitting device in which the discharge was induced and a scan wiring (hereinafter referred to as the “non-selected scan wiring”) adjacent to the selected scan wiring on the side of the electron-emitting device. Besides, luminance measurements were taken from the electron-emitting devices which were driven by the selected scan wiring and in which no discharge was induced. A high-speed camera (VFC-300 produced by FOR-A COMPANY LIMITED) was used for the luminance measurements. Voltages were applied between cathode electrodes 5 and gate electrodes 4 via appropriate wirings. Regarding the electron-emitting device in which the discharge was induced, a voltage of 0 to +20 V was applied to the information wiring 10 and a pulse voltage of 0 to −10 V was applied to the scan wiring 12. Regarding the electron-emitting devices in which no discharge was induced, a voltage of 0 to +10 V was applied to the information wiring 10 and a voltage of 0 to −10 V was applied to the scan wiring 12. At the same time, a high DC voltage of 12 kV was applied to the metal back 45 of the face plate 46.

Results of the measurements taken by the above method are as follows. Regarding the comparison image display apparatus, the current on the selected scan wiring was approximately 1 A and the current on the non-selected scan wiring was 0 A. In the electron-emitting devices in which no discharge was induced, luminance drops during discharge were about 8%. Regarding the evaluation image display apparatus, the current on the selected scan wiring was approximately 0.5 A and the current on the non-selected scan wiring was approximately 0.5 A. In the electron-emitting devices in which no discharge was induced, luminance drops during discharge were about 4%. Thus, when the discharge induction electrode 9 is installed as with the configuration used in the present example, the discharge induction electrode 9 can cause electrical discharges and guide the discharge current to the non-selected scan wiring, resulting in reduced image distortion.

### Example 2

### Production of Rear Plate

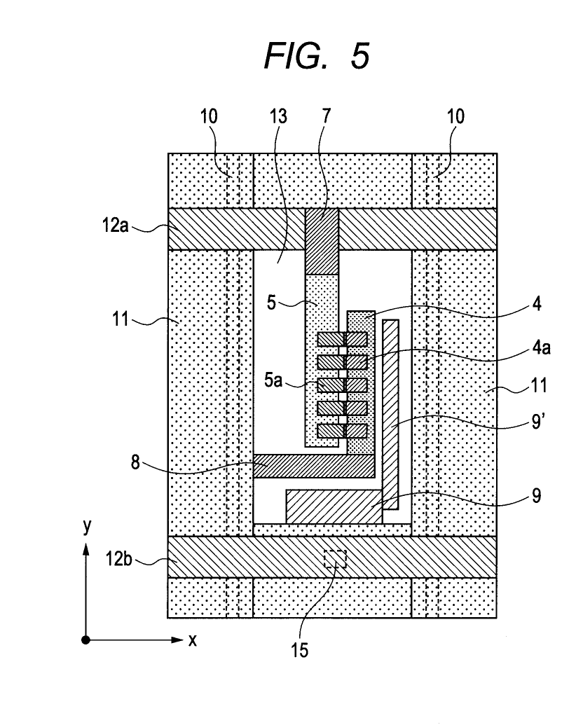

In the present example, the rear plate shown in FIG. 5 was produced. The electron-emitting device according to the present example was produced by the same method as example 1 and had the same configuration as in example 1 except that the gate electrode 4 had a different length and that the discharge induction electrode 9 had a different shape. In the present example, the gate electrode 4 was 200 μm long, and a discharge induction electrode 9′ with a length of 210 μm was added as the discharge induction electrode 9. That is, the exposed portion of the discharge induction electrode 9 was extended into a space between the electron-emitting device 13 and a first of two adjacent information wirings (first and second information wirings) 10 sandwiching the electron-emitting device 13. The distance from the discharge induction electrode 9 to the minute gaps 6 was set so as not to exceed 150 μm.

(Production of Image Display Apparatus)

The electron-emitting devices produced by the above method were arranged in a 720×160 matrix to produce the image display apparatus shown in FIG. 2 by the same method as example 1. Furthermore, an evaluation image display apparatus was produced using the same method.

Also, another image display apparatus without a discharge induction electrode 9 was produced for comparison. The comparison image display apparatus had the same configuration as the evaluation image display apparatus according to the present example except that the comparison image display apparatus did not have a discharge induction electrode 9 and the fabrication method of the comparison image display apparatus was the same as that of the evaluation image display apparatus according to the present example except that no discharge induction electrode 9 was installed during production of the rear plate, and thus description thereof will be omitted.

(Evaluation of Image Display Apparatus)

The evaluation image display apparatus and comparison image display apparatus thus produced were matrix-driven under the same conditions as example 1. Using the same method as in example 1, the following values were measured: the value of current on the selected scan wiring driving the electron-emitting device in which the discharge was induced, value of current on the scan wiring adjacent to the selected scan wiring on the side of the electron-emitting device, and luminance of the electron-emitting devices which were driven by the selected scan wiring and in which no discharge was induced.

Results of the measurements taken by the above method are as follows. Regarding the comparison image display apparatus, the current on the selected scan wiring was approximately 1 A and the current on the non-selected scan wiring was 0 A. In the electron-emitting devices in which no discharge was induced, luminance drops during discharge were approximately 2%. Regarding the evaluation image display apparatus, the current on the selected scan wiring was 0.5 μA and the current on the non-selected scan wiring was 0.5 A. In the electron-emitting devices in which no discharge was induced, luminance drops during discharge were approximately 4%. Thus, with the configuration used in the present example, the discharge induction electrode 9 can cause electrical discharges and guide the discharge current to the non-selected scan wiring, resulting in reduced image distortion.

### Example 3

### Production of Rear Plate

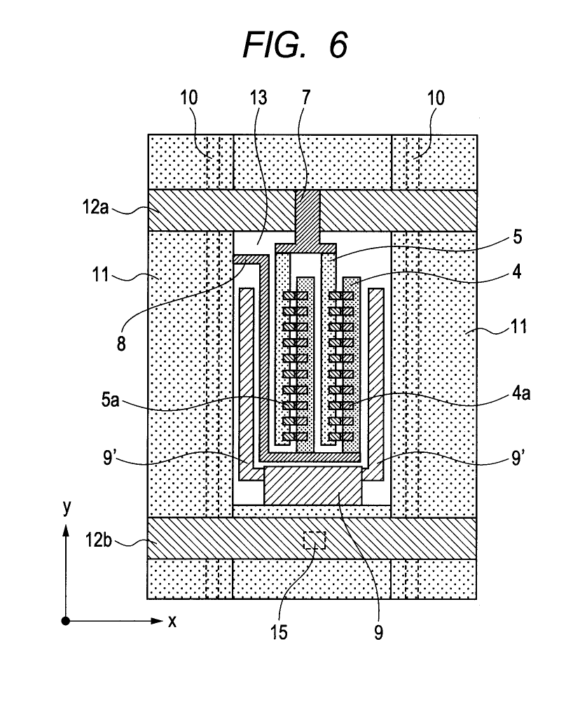

In the present example, the rear plate shown in FIG. 6 was produced. The electron-emitting device according to the present example was produced by the same method as example 2 and had the same configuration as in example 2 except that two each of the gate electrodes 4 and cathode electrodes 5 were installed and that the discharge induction electrode 9 had a different shape. In the present example, the gate electrodes 4 were 200 μm long and two discharge induction electrodes 9′ with a length of 210 μm were installed as the discharge induction electrode 9 at distances of 150 μm or less from the minute gaps 6 of the respective electrodes 4 by extending from the discharge induction electrode 9. That is, the exposed portions of the discharge induction electrode 9 were extended into respective spaces between the electron-emitting device 13 and two adjacent information wirings (first and second information wirings) 10 sandwiching the electron-emitting device 13. The distance from the discharge induction electrode 9 to the minute gaps 6 was set so as not to exceed 150 μm.

(Production of Image Display Apparatus)

The electron-emitting devices produced by the above method were arranged in a 720×160 matrix to produce the image display apparatus shown in FIG. 2 by the same method as example 2. Furthermore, an evaluation image display apparatus was produced using the same method.

Also, another image display apparatus without a discharge induction electrode 9 was produced for comparison. The comparison image display apparatus had the same configuration as the evaluation image display apparatus according to the present example except that the comparison image display apparatus did not have a discharge induction electrode 9 and the fabrication method of the comparison image display apparatus was the same as that of the evaluation image display apparatus according to the present example except that no discharge induction electrode 9 was installed during production of the rear plate, and thus description thereof will be omitted.

(Evaluation of Image Display Apparatus)

The evaluation image display apparatus and comparison image display apparatus thus produced were matrix-driven under the same conditions as example 2. Using the same method as in example 2, the following values were measured: the value of current on the selected scan wiring driving the electron-emitting device in which the discharge was induced, value of current on the scan wiring adjacent to the selected scan wiring on the side of the electron-emitting device, and luminance of the electron-emitting devices which were driven by the selected scan wiring and in which no discharge was induced.

Results of the measurements taken by the above method are as follows. Regarding the comparison image display apparatus, the current on the selected scan wiring was approximately 1 A and the current on the non-selected scan wiring was 0 A. In the electron-emitting devices in which no discharge was induced, luminance drops during discharge were approximately 8%. Regarding the evaluation image display apparatus, the current on the selected scan wiring was approximately 0.5 μA and the current on the non-selected scan wiring was 0.5 A. In the electron-emitting devices in which no discharge was induced, luminance drops during discharge were approximately 4%. Thus, with the configuration used in the present example, the discharge induction electrode 9 can cause electrical discharges and guide the discharge current to the non-selected scan wiring, resulting in reduced image distortion.

An embodiment and examples of the present invention has been described concretely, but the present invention is not limited to the embodiment described above. Various modifications can be made based on the technical idea of the present invention. For example, the numeric values and components cited in the above embodiment are purely exemplary, and other numeric values and components may be used as required. For example, in the above embodiment, a television set equipped with an image signal generation circuit (not shown), a drive circuit (not shown) and the image display apparatus may be constructed by connecting an acoustic apparatus (not shown) or the like to a video information receiver (not shown).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-167063, filed Jul. 26, 2010, which is hereby incorporated by reference herein in its entirety.

What is claimed is:

1. An image display apparatus comprising:
a rear plate provided with a plurality of information wirings, a plurality of scan wirings arranged over the information wirings in a direction of crossing the information wirings, an insulating layer arranged between the information wirings and the scan wirings along the scan wirings, and a plurality of electron-emitting devices each electrically connected to each of the information wirings and to each of the scan wirings; and
a face plate provided with an anode electrode and a light-emitting member irradiated with an electron emitted from the electron-emitting device, and arranged in opposition to the rear plate, wherein
the electron-emitting device is arranged between the scan wirings adjacent to each other and is electrically connected to one of the adjacent scan wirings, the other of the adjacent scan wirings is electrically connected to a discharge induction electrode through a contact hole penetrating the insulating layer, and wherein
one end portion of the discharge induction electrode is covered with the insulating layer, the other end portion of the discharge induction electrode is extended from the insulating layer toward the electron-emitting device.

2. The image display apparatus according to claim 1, wherein
the discharge induction electrode meets following formulas:
Ee=P×Cp×ρ×Tm (a);
Ea=R×I²×t₁ (b); and
Ee>Ea (c), wherein
P is volume [m3] of the discharge induction electrode between a portion thereof connected to the scan wirings and an end thereof opposite to the portion connected,
Cp is specific heat [J/kgK] at a constant pressure of the discharge induction electrode,
ρ is density [kg/m³] of the discharge induction electrode,
Tm is melting point [K] of the discharge induction electrode,
R is a resistance [Ω] of the discharge induction electrode between the portion thereof connected to the scan wirings and the end thereof opposite to the portion connected,
I is allowable current value [A] of the discharge induction electrode, and
t₁ is duration [sec] of discharge current flowing through the discharge induction electrode.

3. The image display apparatus according to claim 1, wherein
the electron-emitting devices are driven in a matrix manner by successively selecting the scan wirings so that the scan wiring in a selected sate is adjacent to the scan wiring in a non-selected sate.

4. The image display apparatus according to claim 1, wherein
the electron-emitting device is further arranged between the information wirings adjacent to each other, and
the other end portion of the discharge induction electrode extended from the insulating layer is further extended between one of the adjacent information wirings and the electron-emitting device between the adjacent information wirings.

5. The image display apparatus according to claim 1, wherein
the electron-emitting device is further arranged between the information wirings adjacent to each other, and
the other end portion of the discharge induction electrode extended from the insulating layer is further extended between each of one and the other of the adjacent information wirings and the electron-emitting device between the adjacent information wirings.

6. The image display apparatus according to claim 1, wherein
the other end portion of the discharge induction electrode extended from the insulating layer is exposed.
